(19) United States
(12) Patent Application Publication
(10) Pub. No.: US 2004/0189693 A1
(43) Pub. Date: Sep. 30, 2004

(54) Approach for visually depicting web server activity on a graphical user interface

(75) Inventor: Marc Kenig, Mountain View, CA (US)

Correspondence Address: HICKMAN PALERMO TRUONG & BECKER, LLP, 1600 WILLOW STREET, SAN JOSE, CA, 95125, US

(73) Assignee: ORACLE INTERNATIONAL CORPORATION, Redwood Shores, CA (US)

(21) Appl. No.: 10/400,298

(22) Filed: Mar. 26, 2003

(51) Int. Cl. G09G 5/00

(52) U.S. Cl. 345/736

(57) ABSTRACT

Web server activity is visually depicted on a Graphical User Interface (GUI) by generating and displaying on the GUI a plurality of GUI objects. One or more attributes of the plurality of GUI objects visually depict, over time, one or more sources and processing status of a plurality of requests for content processed by the Web server. The one or more attributes of the plurality of GUI objects may also visually depict other attributes of the plurality of requests for content, for example the types of requests contained in the plurality of requests for content processed by the Web server. The one or more attributes of the plurality of GUI objects may visually depict Internet Protocol (IP) addresses of devices that generated the plurality of requests for content, or times at which the Web server processed the plurality of requests for content. The one or more attributes of the plurality of GUI objects may include, without limitation, sizes, shapes, colors and locations of the plurality of GUI objects.

### FIELD OF THE INVENTION

This invention relates generally to Web servers and, more specifically, to an approach for visually depicting Web server activity on a graphical user interface.

### BACKGROUND OF THE INVENTION

The approaches described in this section are approaches that could be pursued, but not necessarily approaches that have been previously conceived or pursued. Therefore, unless otherwise indicated, the approaches described in this section may not be prior art to the claims in this application and are not admitted to be prior art by inclusion in this section.

The worldwide packet switched network, known as the “Internet”, has become a valuable research tool for gathering information and for conducting electronic commerce. On the Internet, information is typically maintained on Web servers that provide information in the form of Web pages. One important issue associated with Web servers is performance and failure analysis. Many Web servers operate in E-commerce or other time-critical environments where it is important to quickly observe and analyze the performance or failure of a Web server. Slow Web server response times or failures can adversely affect businesses, as customers will readily choose alternative providers that provide faster and more reliable service.

One approach for analyzing the performance of Web servers is manual inspection of Web server log files. Web server log files are data files that maintain a history of requests for content received and processed by Web servers. A typical Web server log file is a text file that records, for each request for content, the Internet Protocol (IP) address of the device where the request for content originated, the date and time (timestamp) at which the request for content was processed by the Web server, a copy of the request, an HyperText Transfer Protocol (HTTP) Result Code that specifies a processing status of the request for content and the number of bytes of content that were served by the Web server. One example log file format is the Apache “common” log format.

To evaluate the performance of a Web server using manual inspection, administrative personnel manually inspect Web server log files in an attempt to analyze the activity of a Web server around a time of interest, for example around the time a Web server was performing poorly or failed. This is conventionally done by viewing Web server log files on a computer monitor, or by reviewing printed copies of one or more portions of Web server log files, to identify entries with HTTP Result Codes that indicate errors in processing of requests. These requests are then analyzed to characterize the source of the problem.

One problem with manually inspecting Web server log files is that a typical Web server log file contains millions of entries. Moreover, many of the entries are extraneous to application flow. For example, many entries correspond to requests for content for web pages, such as images, and not to Web pages themselves. Administrative personnel must manually cull through thousands of Web server log file entries searching for entries with HTTP Result Codes and timestamps that are consistent with the observed behavior at the time of interest. This problem is exacerbated by Web servers that generate log file entries when the Web servers receive the requests for content, rather than when the Web servers process the requests for content. In this situation, the HTTP Result Codes may not reflect a problem until several minutes have passed and timeouts have expired. Administrative personnel must then work backwards in time through the Web server log files in an attempt to evaluate the Web server activity around the time the problem might have first occurred. Furthermore, some Web sites are implemented with several, and sometimes many, Web servers that each has an associated Web server log file. In this situation, administrative personnel must examine the contents of multiple Web server log files in parallel.

Another problem with manually inspecting Web server log files is that entries are conventionally arranged chronologically in Web server log files. Thus, for an active Web server, requests for content from any particular source may be separated by hundreds, or even thousands, of requests from other sources that are not of interest. This makes it difficult to analyze processing trends for a particular source of requests for content, since a large number of entries may have to be examined. Using manual inspection to analyze processing trends across multiple sources of requests, for example for requests for certain types of content, is even more difficult, if not impossible.

Another approach for analyzing the performance of Web servers involves using statistical tools to automatically filter log files and reduce the amount of data that must be manually examined. For example, a statistical tool may be used to search a Web server log file and identify all entries associated with requests from a particular source. This is done, for example, by identifying all requests for content that specify a particular IP address. These entries may then be manually examined in an attempt to analyze processing trends with respect to the particular source. There are several problems with using conventional statistical tools to analyze Web server activity. First, the approach can be computationally expensive and time consuming when large Web server log files are processed because of the large amount of data that must be processed. It is sometimes difficult to know where to begin analyzing a log file that reflects requests for content made over a long period of time. As a result, most statistical tools process entire log files. Also, statistical tools are generally not sufficiently flexible to perform the desired processing. For example, convention statistical tools use basic text-based commands that do not provide the capability to analyze Web server activity across multiple sources of requests for content.

Based upon the foregoing, there is a need for an approach for analyzing the performance of Web servers that does not suffer from limitations in prior approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram that depicts an architecture configured to visually depict Web server activity on a Graphical User Interface (GUI) according to an embodiment of the invention.

FIG. 2 is a block diagram of a graph generated on a GUI that depicts Web server activity in accordance with an embodiment of the invention.

FIG. 3 is a flow diagram that depicts an approach for processing Web server log file data in accordance with an embodiment of the invention.

FIG. 4 is a block diagram that depicts a hash table of requested content by IP address value.

FIG. 5 is a block diagram that depicts a hash table of requested content by Uniform Resource Locator (URL) and HTTP result code.

FIG. 6 is a block diagram that depicts a computer system on which embodiments of the present invention may be implemented.

### DETAILED DESCRIPTION OF THE INVENTION

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention. Various aspects of the invention are described hereinafter in the following sections:

I. OVERVIEW

II. WEB SERVER ACTIVITY VISUALIZATION ARCHITECTURE

III. VISUALIZATION OF WEB SERVER ACTIVITY ON A GUI

IV. PROCESSING WEB SERVER ACTIVITY DATA

V. USING VISUALIZATION DATA TO ANALYZE PROBLEMS

VI. IMPLEMENTATION MECHANISMS, ALTERNATIVES & EXTENSIONS

I. Overview

Web server activity is visually depicted on a Graphical User Interface (GUI) by generating and displaying on the GUI a plurality of GUI objects. The one or more attributes of the plurality of GUI objects visually depict, over time, one or more sources and processing status of a plurality of requests for content processed by the Web server. The one or more attributes of the plurality of GUI objects may also visually depict other attributes of the plurality of requests for content, for example the types of requests contained in the plurality of requests for content processed by the Web server. In other embodiments of the invention, the one or more attributes of the plurality of GUI objects may visually depict Internet Protocol (IP) addresses of devices that generated the plurality of requests for content, or times at which the Web server processed the plurality of requests for content. As described in more detail hereinafter, the one or more attributes of the plurality of GUI objects may include, without limitation, sizes, shapes, colors and locations of the plurality of GUI objects.

According to one embodiment of the invention, the approach includes processing Web server log file data and generating intermediate data that is used to determine the attributes for and generate the GUI objects on the GUI. The intermediate data includes data that specifies requested content by time by Internet Protocol (IP) addresses of devices from which the plurality of requests for content originated. The intermediate data also includes data that specifies requested content by URL and HTTP Result Code.

II. Web Server Activity Visualization Architecture

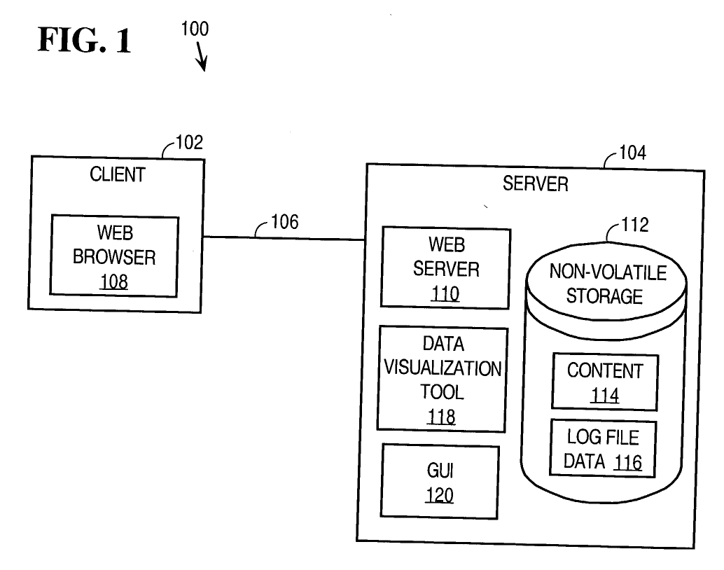

FIG. 1 is a block diagram that depicts an architecture 100 configured to visually depict Web server activity on a GUI according to an embodiment of the invention. Architecture 100 includes a client 102 communicatively coupled to a server 104 via a communications link 106. Client 102 and server 104 may be implemented on any type of computing architectures and may be co-located on a common node or on separate nodes, for example in a distributed computing application, depending upon the requirements of a particular implementation. Communications link 106 may be implemented by any medium or mechanism that provides for the exchange of data between client 102 and server 104. Examples of communications link 106 include, without limitation, a network such as a Local Area Network (LAN), Wide Area Network (WAN), Ethernet or the Internet, or one or more terrestrial, satellite or wireless links.

A web browser 108 executes on client 102 and generates and sends requests for content to server 104 in response to user input. For example, a user viewing a web page on web browser 108 selects a link in the web page to another web page. In response to this user input, web browser 108 generates a request for the other web page specified in the link and sends the request to server 104 via communications link 106. Web browser 108 may be implemented by any type of web browser using any type of communications protocol and the invention is not limited to any particular type of web browser or communications protocol.

Server 104 includes a Web server 110 and a non-volatile storage 112. Web server 110 executes on server 104 and processes requests for content received from web browser 108. Processing requests may include retrieving content 114 from a non-volatile storage 112 and providing the retrieved content 114 to web browser 108 over communications link 106. For example, suppose that web browser 108 generates and sends to Web server 110 a request for a particular web page that is identified by a particular Uniform Resource Locator (URL). Web server 110 retrieves the particular web page from content 114 on non-volatile storage 112 and “serves,” i.e., provides, the particular web page to web browser 108. Content 114 may change over time, for example, by being generated programmatically by a program executing on server 104. Alternatively, content 114 may be static and stored on non-volatile storage 112.

Web server 110 may be implemented by any number of any type of Web servers and the invention is not limited to any particular type of Web server. Although embodiments of the invention are described hereinafter in the context of Web server 110 as a single Web server, this is done for explanation purposes only, and the invention is not limited to single Web server implementations. An example of Web server 110 is an Apache Web server. Non-volatile storage 112 may be any type of non-volatile storage, for example, one or more disks.

Log file data 116 is created and maintained on non-volatile storage 112 in one or more data files. One or more portions of log file data 116 may be maintained in a volatile storage and periodically stored to non-volatile storage 112, depending upon the requirements of a particular implementation. According to one embodiment of the invention, log file data 116 is created and maintained by Web server 110. For example, when Web server 110 is first instantiated, log file data 116 is created. Thereafter, data is appended to log file data 116 in response to Web server 110 activity. Other Web servers may also append data to Log file data 116, depending upon the particular Web site architecture.

Log file data 116 contains data that specifies one or more attributes of requests for content processed by Web server 110. The particular data maintained in log file data 116 may vary, depending upon the requirements of a particular implementation. According to one embodiment of the invention, log file data 116 specifies, for each request for content, the IP address of the device where the request for content originated, the date and time (timestamp) at which the request for content was processed by Web server 110, a copy of the request and an HTTP Result Code. An example request for content is “GET/brands/ox/media/cache/en/b-go.gif HTTP/1.0.” The particular format of log file data 116 may vary depending upon the requirements of a particular application. One example log file data format is the Apache “common” log format.

III. Visualization of Web Server Activity on a GUI

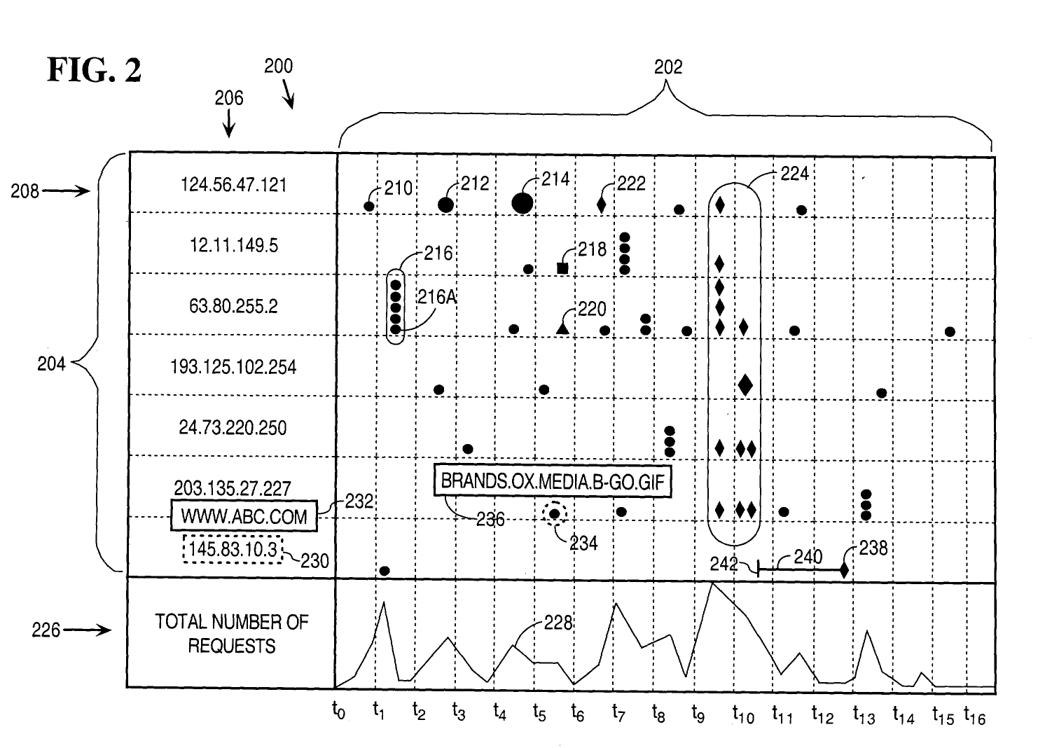

FIG. 2 is a block diagram of a report 200 that depicts Web server activity in accordance with an embodiment of the invention. Report 200 includes a star field region 202 that contains GUI objects that visually depict over time, one or more sources and processing status of a plurality of requests for content processed by Web server 110. Star field region 202 includes rows 204, where each row corresponds to requests for content that originated from a device having a particular IP address. Column 206 contains an IP address associated with each row 204. Thus, GUI objects in each row 204, within star field region 202, depict the status, over time to through t₁₆, of requests that originated from a particular IP address. For example, the GUI objects displayed in row 208, within star field region 202, visually depict the status of requests for content that originated from a device having an IP address of “124.56.47.121” and that were processed by Web server 110 during time t₀ through t₁₆. As another example, the GUI objects in star field region 202 may visually depict the type of requests for content processed by Web server 110. For example, a first GUI object displayed on GUI 120 in a first color may visually depict that the associated request for content specified a first type of content, while a second GUI object displayed on GUI 120 in a second color may visually depict that the associated request for content specified a second type of content. Report 200 may be generated using any type of mechanism, depending upon the implementation. For example, report 200 may be generated in Adobe Scalable Vector Graphics Format.

According to one embodiment of the invention, one or more attributes of the GUI objects displayed in star field region 202 indicate one or more attributes of the requests for content processed by Web server 110. A variety of attributes of GUI objects may be used to visually convey to users the one or more attributes of the requests for content processed by Web server 110. Furthermore, the attributes of GUI objects may visually depict different aspects of the one or more attributes of the requests for content processed by Web server 110.

According to one embodiment of the invention, size attributes of GUI objects are used to visually depict one or more attributes of the requests for content processed by Web server. More specifically, the relative differences in size, or area, of GUI objects indicate the number of identical requests for content received from the same source during a specified time. For example, in FIG. 2, a GUI object 210 is a circle that indicates that one or more requests for content were received from a device having an IP address of “124.56.47.121” and processed by Web server 110 during the time t₀ to t₁. A GUI object 212 is a circle that indicates that one or more requests for content were received from the same device and processed by Web server 110 during a specified time between the time t₂ to t₃. In this example, the specified time is a particular time, or a range of time, that is defined by the time range t₀ to t₁₆ and the granularity of report 200.

The relatively larger size of GUI object 212 compared to GUI object 210 indicates that a greater number of identical requests were received from the same device and processed within a specified time. For example, GUI object 210 may indicate that one request for content was processed within the specified time, while GUI object 212 indicates that two identical requests for content were received from the same device and processed during a different specified time. As another example, a GUI object 214 indicates that three identical requests for content were received from the same device and processed within a different specified time. According to one embodiment of the invention, all requests for content associated with a particular GUI object are identical requests for content, but that requests for content associated with different GUI objects, even for the same source device, are not necessarily identical, and in many situations are different.

In contrast to the foregoing, a set of GUI objects indicated by reference numeral 216 indicate that multiple different requests for content were received from a device having the IP address of “63.80.255.2” and processed by Web server 110 during a specified time. The vertical placement of the set of GUI objects provides a visual indication that the requests for content were processed by Web server 110 during a particular specified time. The use of five, vertically-aligned GUI objects indicates that five different requests for content were processed by Web server 110 during the particular specified time. Furthermore, since the five GUI objects are the same size, the same number of each of the five different requests for content was processed by Web server 110 during the particular specified time. In this example, position attributes of GUI objects are used to visually depict the status of requests for content processed by Web server 110.

According to one embodiment of the invention, the relative vertical locations of GUI objects 216 indicates a time ordering in which the corresponding requests for content were processed by Web server 110. In the present example, GUI objects associated with requests for content are stacked vertically starting at the bottom of the row. Thus, the request for content associated with GUI object 216A was processed first by Web server 110 among the five requests for content associated with GUI objects 216.

According to another embodiment of the invention, color attributes of GUI objects are used to visually depict one or more attributes of the requests for content processed by Web server 110. For example, GUI objects may be displayed on report 200 using “cool” colors, such as blue or green, to indicate that the associated requests for content were successfully processed. Other colors, for example “hot” colors, such as yellow and red, may be used to indicate a problem or error, or suspected problem or error, in processing requests. For example, different colors may be used to visually depict that a request for content could not be processed, that the requested content could not be located, or that the request for content specified unknown content. The particular color scheme employed may vary depending upon the requirements of a particular implementation, and the invention is not limited to any particular approach.

According to another embodiment of the invention, shape attributes of GUI objects are used to visually depict one or more attributes of the requests for content processed by Web server 110. For example, the shape of GUI objects displayed on report 200 may indicate that the associated requests for content are currently being processed, were successfully processed, or problems or errors prevented successful processing. For example, a round shaped GUI object, such as GUI object 210, may indicate that associated requests for content have been successfully processed. A square or triangle shaped GUI object, such as GUI objects 218, 220, respectively, may indicate that associated requests for content are currently being processed. A diamond shaped GUI object, such as GUI object 222, may indicate that associated requests for content have not been successfully processed because of a problem or error. According to one embodiment of the invention, the shape of a GUI object visually depicts problems or reasons why associated requests for content have not been successfully processed. For example, a diamond-shaped GUI object may indicate that an associated request for content was not successfully processed before a timeout expired. A different GUI object shape may be used to visually depict that a request for content specified a request that was not recognized by Web server 110. This may be used, for example, in situations when web browser 108 generates an invalid request. Yet another GUI object shape may be used to visually depict that the requested content was unknown to Web server 110. Any number and types of shapes of GUI objects may be used to indicate a problem or error in processing requests, depending upon the requirements of a particular implementation.

According to another embodiment of the invention, a row 226 of report 200 contains GUI objects in the form of a sub-graph 228, that visually depicts a total number of requests for content processed by Web server 110 at various times during times t₀ and t₁₆.

According to another embodiment of the invention, GUI objects in column 206 of report 200 are user selectable GUI objects. For example, a user may select GUI object 230 using a mouse. This may be performed, for example, by the user moving a mouse cursor over GUI object 230 and pressing the left button on the mouse. Alternatively, simply moving the mouse cursor of GUI object 230, a so-called “mouse over” action, may be sufficient to select GUI object 230.

In response to the selection of a GUI object in column 206 of report 200, a domain name corresponding to the IP address associated with the selected GUI object is obtained and visually depicted to the user on report 200. Obtaining a corresponding domain name may be performed, for example, using a Domain Name Search (DNS) lookup. For example, suppose that a user selects GUI object 230, having an associated IP address of “145.83.10.3”. In response to the user selecting GUI object 230, a DNS lookup is performed on IP address “145.83.10.3” to obtain the corresponding domain name, which in the present example is “www.abc.com”. A GUI object 232 is generated and displayed on report 200 to visually depict the corresponding domain name to the user. In the present example, GUI object 232 visually depicts that the corresponding domain name for IP address “145.83.10.3” is “www.abc.com”. A variety of techniques may be used to visually depict domain names corresponding to IP addresses contained in column 206 of report 200, depending upon the requirements of a particular implementation, and the invention is not limited to any particular approach.

According to another embodiment of the invention, in response to the selection, e.g., a “mouse over”, of a GUI object 234, at least a portion of the corresponding request is visually depicted to the user on report 200. For example, GUI object 236 is generated and displayed on report 200 to visually depict at least a portion of the actual request that corresponds to GUI object 234. In the present example, GUI object 236 indicates that the request associated with selected GUI object 234 is “brands.ox.media.b-go.gif”. A variety of techniques may be used to visually depict requests for content, depending upon the requirements of a particular implementation, and the invention is not limited to any particular approach. According to another embodiment of the invention, in response to selection of GUI object 234, a time at which a corresponding request was processed by web server 110 is displayed on report 200. The time may be obtained from timestamp information contained in log file data 116. This may be helpful in situations where the scale of report 200 reflects a long time period and it is difficult to visually determine the exact time at which a particular request for content was processed.

IV. Processing Web Server Activity Data

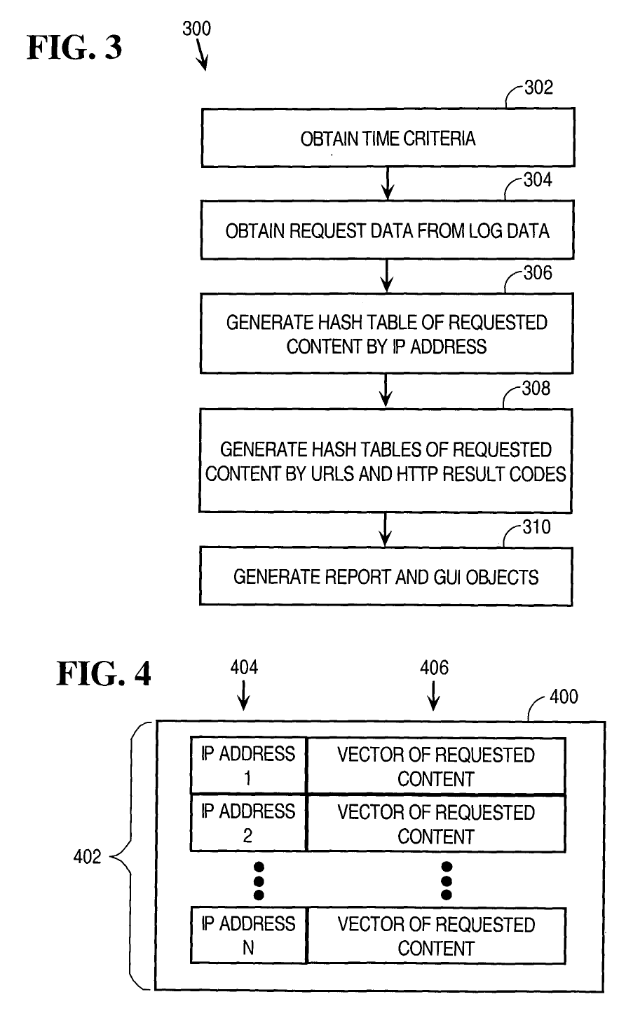

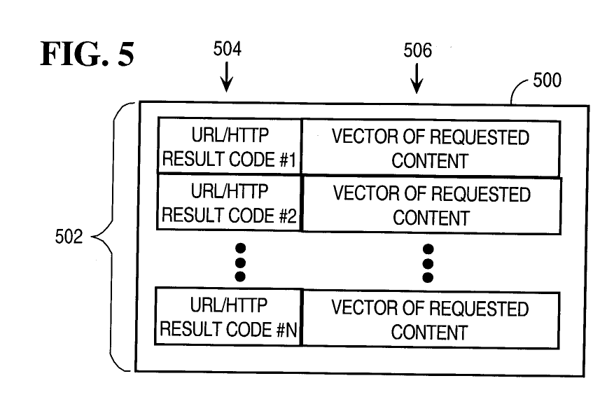

According to one embodiment of the invention, server 104 includes a data visualization tool 118 configured to visually depict Web server activity on a GUI, such as GUI 120 on server 104. As described in more detail hereinafter, data visualization tool 118 processes log file data 116 based upon specified time criteria and generates intermediate data. Data visualization tool 118 then processes the intermediate data to determine the attributes for and generate GUI objects on the GUI that visually depict the activity of Web server 110. The approach for processing Web server activity data is now described with reference to a flow diagram 300 of FIG. 3, a hash table 400 of FIG. 4 and a hash table 500 of FIG. 5.

In step 302, data visualization tool 118 obtains time criteria. The time criteria are used to determine which data from log file data 116 is to be used to generate report 200 and its constituent GUI objects. According to one embodiment of the invention, the time criteria express a time range of data that is to be considered, the particular form of which may vary, depending upon the requirements of a particular implementation, and the invention is not limited to any particular form. For example, the time criteria may specify a start time and an end time. As another example, the time criteria may specify a particular time and a delta. In this situation, a start time is the particular time minus the delta and an end time is the particular time plus the delta. As another example, the time criteria may specify all request data from the beginning of log file data 116 forward for a specified amount of time, or until an absolute time. Similarly, the time criteria may specify all request data from the end of log file data 116 backward for a specified amount of time, or until an absolute time. The time criteria may be obtained from a user through a GUI, or other means. The time criteria may alternatively be obtained from a volatile or non-volatile storage, or from a remote entity.

In step 304, data visualization tool 118 obtains request data that satisfies the time criteria from log file data 116. This may be performed using a binary search to locate records or entries in log file data 116 that satisfy the time criteria. For example, suppose that the time criteria specifies a start time and an end time. In this situation, entries in log file data 116 that have a time stamp that satisfies the time criteria, i.e., falls between the start and end times, are selected for processing. Request data may also be obtained from multiple log files, for example when redundant log files are used, or in multiple Web server implementations. According to one embodiment of the invention, when multiple log files are used, log file entries are read from the log files in time sequential order and then processed. For example, suppose that log file data 116 is stored in three log files A, B and C. First each log file is accessed and the first entry to be read from each log file is identified based upon the time criteria to be applied. The entries are then read and processed from log files A, B and C in time sequential order. Using a binary search to locate entries in log file data 116 that satisfy the time criteria saves a significant amount of computational resources and time since potentially millions on entries that do not satisfy the time criteria need not be examined and processed.

In step 306, data visualization tool 118 generates hash table 400 of requested content by IP address value. Hash table 400 includes N number of rows 402, where each row 402 contains an IP address value 404 and a vector of requested content 406. According to one embodiment of the invention, IP address values 404 are the IP addresses of devices from which requests for content originated. Alternatively, IP address values 404 may be a result of performing a hash function on the IP addresses of devices from which the requests for content originated. The resulting values are then used as index values into a separate index of IP addresses. This approach reduces the duplicate storage of redundant IP addresses. Each vector of requested content 406 is associated with a particular IP address value 404 and contains data that identifies content requested from the source associated with the particular IP address value 404. For example, suppose that a particular IP address value 404 specifies the IP address of a particular device. The particular vector of requested content 406 associated with the particular IP address value 404 contains that that specifies the content requested by the particular device. For example, the particular vector of requested content 406 may specify the URLs, or portions of the URLs, of Web pages requested by the particular device. According to one embodiment of the invention, the particular vector of requested content 406 also indicates an order in which the items were requested. The particular vector of requested content 406 may also specify a count that indicates a number of times that the content was requested, so that duplicate requested content may be eliminated. The items requested by the particular device are obtained from the entries in log file data 116.

Steps 304 and 306 may be performed in an iterative manner, rather than all of the request data first being obtained in step 304 followed by the generation of the hash tables in step 306. For example, the hash tables may be appended with data as additional request data is read from one or more log files.

In step 308, data visualization tool 118 generates a hash table 500 for each IP address value 404 and for each time slice based upon hash table 400. Hash table 500 includes data that specifies requested content by URL and HTTP result code. As used herein, the term “time slice” refers to the amount of time that each GUI object associated with requests for content represents in star field region 202. For example, GUI object 210 might represent approximately one fifth of the amount of time represented by time t₁ minus time t₀.

Hash table 500 contains N number of rows 502. Each row 402 contains a URL/HTTP Result Code Value 504 and a vector of requested content 506. According to one embodiment of the invention, each URL/HTTP Result Code Value 504 is the result of performing a hash function on each URL/HTTP Result Code combination. Each vector of requested content 506 is associated with a particular URL/HTTP Result Code Value 504 and contains data that identifies content requested from the source associated with the particular IP address and a particular HTTP Result Code. The number of rows 502 depends upon the number of request statuses that are to be represented on report 200.

In step 310, data visualization tool 118 generates report 200 and its constituent GUI objects on GUI 120 using the set of hash tables 500 generated in step 308. Each hash table 500 contains the data necessary to generate all of the GUI objects for a particular IP address and time slice. Each row 502 contains the data necessary to generate a particular GUI object for a request for content, since each row 502 specifies the number of requests made for content, from an IP address, during a time slice, where the processing of the request caused a particular HTTP Result Code to be generated. According to one embodiment of the invention, the attributes of each GUI object associated with a request for content are determined based upon the HTTP Result Code for the request. For example, a lookup table may be used to determine the attributes for a particular GUI object, based upon the HTTP Result Code. Each row 502 of each hash table 500 is processed until all hash tables 500 have been processed. After all hash tables 500 have been processed, a legend and other GUI objects may be added to report 200.

V. Using Visualization Data to Analyze Problems

The approach described herein for visually depicting Web server activity on a GUI is very beneficial in analyzing Web server activity and performance and for performing causal analysis of problems. In particular, being able to view a visual depiction of how requests for content from different sources are being processed over time allows administrative personnel to quickly characterize and solve problems. For example, the members of a set of GUI objects identified by reference numeral 224 share a common shape attribute, namely, that all of the GUI objects are diamond-shaped. GUI objects 224 may also be displayed in a distinctive color, such as red, to indicate that the requests for content were not successfully processed. The set of GUI objects 224 also share a common location attribute, namely, that they are all associated with requests for content that were processed by Web server 110 between times t₉ and t₁₁. Suppose that a diamond-shaped GUI object indicates that a particular type of error had occurred during the processing of associated requests for content. In this situation, based upon the color, shape and location of attributes of GUI objects 224, administrative personnel are able to quickly determine that none of the requests for content processed by Web server 110 between times t₉ and t₁₁ were successfully processed. It is therefore likely that the errors were caused by a global event that affected all requesters, rather than a local event that affected particular requesters.

Also, as described herein, the administrative personnel may select a GUI object associated with a particular IP address that is experiencing a problem and quickly and easily determine the source of the requests for content. The administrative personnel may also select a GUI object for a particular request for content and immediately view the exact request for content as provided by the requestor, and also the exact time that the particular request was processed by Web server 110. This information is often very valuable to administrative personnel who are attempting to characterize and solve a problem with Web server 110.

According to another embodiment of the invention, GUI objects are used to visually depict a time at which an error occurred that prevented processing of a request for content. A GUI object 238 is associated with a particular request for content that could not be processed because of an error. For example, the particular request for content may not have been processed within a specified time, causing a timeout error. A GUI object in the form of a lead line 240 visually depicts a time range over which the particular process for content could not be processed prior to the occurrence of the timeout error. A GUI object in the form of a start line 242 visually depicts a time at which a condition occurred that contributed to the timeout error. For example, start line 242 may indicate a first time at which the particular request for content could not be processed, based upon a timeout length of the error. The timeout value associated with the instance of Web server 110 is variable and may be obtained from the configuration files for Web server 110 or supplied to data visualization tool 118 as a parameter. Timeout values may be content-specific and thus vary depending upon the particular content requested from server 104. For example, a request for a particular program to be executed by Web server 110 on behalf of Web browser 108 may be subject to one timeout value, while a request for a Web page or graphic may be subject to a different timeout value. The combination of GUI objects 238, 240, 242 allows administrative personnel to see that the particular request for content caused a timeout error just before time t₁₃, as indicated by GUI object 238, and that the particular request for content was first not able to be processed at a time between time t₁₀ and t₁₁, as indicated by GUI object 242.

The approach described herein for visually depicting Web server activity on a GUI is also beneficial in analyzing possible errors in client-side applications. For example, suppose that Web browser 108 contained a programming error that caused the generation of improper requests for Web pages. Suppose further that Web browser 108, in response to receiving errors from Web server 110, repeatedly resubmitted the same request. This condition might be reflected on report 200 by a relatively large GUI object that would attract the attention of administrative personnel. The administrative personnel would be able to obtain additional information from report 200 about the source of the problem and take steps to address the problem.

VI. Implementation Mechanisms, Alternative & Extensions

The approach described herein for visually depicting Web server activity on a GUI is not limited to Web server activity and may be used with any type of server activity. For example, the approach may be used to visually depict application server activity on a GUI.

Although the approach described herein for visually depicting Web server activity on a GUI has primarily been described in the context of requests for content that are generated by web browser 108, the approach is not limited to this context and is applicable to requests for content that are generated by any mechanism or process.

Although the functionality of data visualization tool 118 has been depicted in the figures and described herein in the context of being implemented as a separate mechanism or process, the functionality of visualization tool 118 may be integrated into other processing entities, such as Web server 110. The functionality of data visualization tool 118 may be also implemented as a stand-alone mechanism external to server 104 that interacts with server 104, for example, over a communications link. Furthermore, data visualization tool 118 may be implemented on any type of computing platform, depending upon the requirements of a particular implementation.

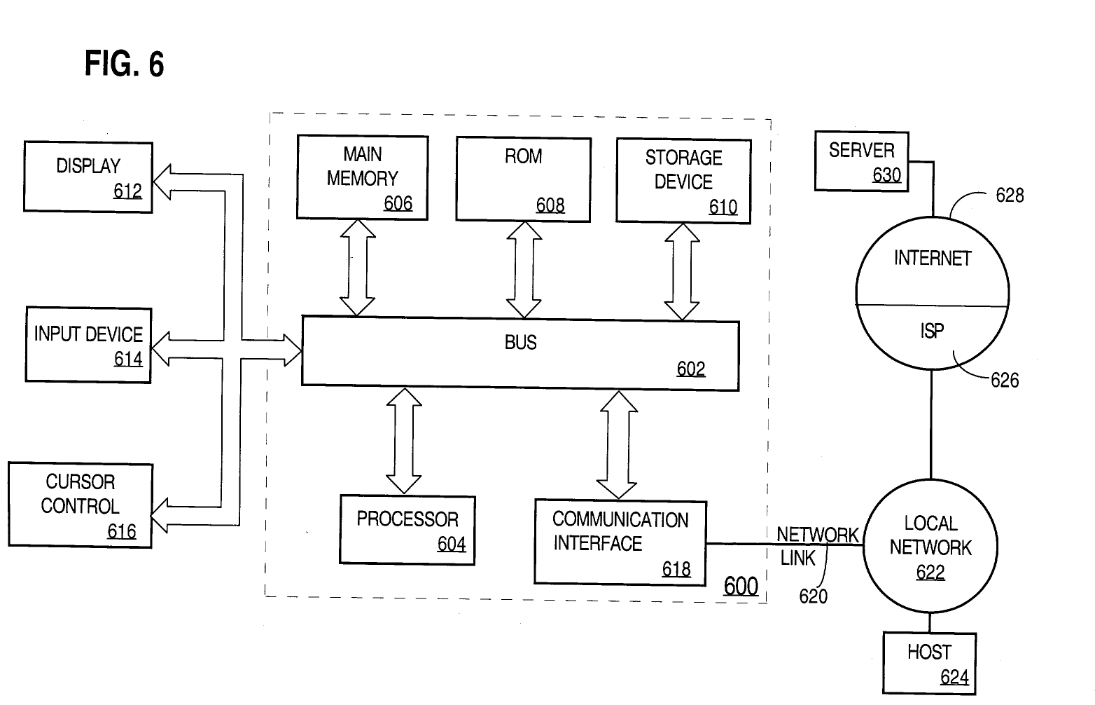

FIG. 6 is a block diagram that illustrates an example computer system 600 upon which an embodiment of the invention may be implemented. Computer system 600 includes a bus 602 or other communication mechanism for communicating information, and a processor 604 coupled with bus 602 for processing information. Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Computer system 600 further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

The invention is related to the use of computer system 600 for visually depicting Web server activity on a GUI. According to one embodiment of the invention, visually depicting Web server activity on a GUI is provided by computer system 600 in response to processor 604 executing one or more sequences of one or more instructions contained in main memory 606. Such instructions may be read into main memory 606 from another computer-readable medium, such as storage device 610. Execution of the sequences of instructions contained in main memory 606 causes processor 604 to perform the process steps described herein. One or more processors in a multi-processing arrangement may also be employed to execute the sequences of instructions contained in main memory 606. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 604 for execution. Such a medium may take many forms, including but not limited to, non-volatile media, volatile media, and transmission media. Non-volatile media includes, for example, optical or magnetic disks, such as storage device 610. Volatile media includes dynamic memory, such as main memory 606. Transmission media includes coaxial cables, copper wire and fiber optics, including the wires that comprise bus 602. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 604 for execution. For example, the instructions may initially be carried on a magnetic disk of a remote computer. The remote computer can load the instructions into its dynamic memory and send the instructions over a telephone line using a modem. A modem local to computer system 600 can receive the data on the telephone line and use an infrared transmitter to convert the data to an infrared signal. An infrared detector coupled to bus 602 can receive the data carried in the infrared signal and place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the worldwide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of carrier waves transporting the information.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618. In accordance with the invention, one such downloaded application provides for visually depicting Web server activity on a GUI as described herein.

Processor 604 may execute the code as it is received, and/or stored in storage device 610, or other non-volatile storage for later execution. In this manner, computer system 600 may obtain application code in the form of a carrier wave.

In the foregoing specification, embodiments of the invention have been described with reference to numerous specific details that may vary from implementation to implementation. Thus, the sole and exclusive indicator of what is, and is intended by the applicants to be, the invention is the set of claims that issue from this application, in the specific form in which such claims issue, including any subsequent correction. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method for visually depicting Web server activity on a Graphical User Interface (GUI), the method comprising the computer-implemented step of:
generating and displaying on the GUI a plurality of GUI objects, wherein one or more attributes of the plurality of GUI objects visually depict, over time, one or more sources and processing status of a plurality of requests for content processed by the Web server.

2. The method as recited in claim 1, wherein the one or more attributes of the plurality of GUI objects further visually depict Internet Protocol (IP) addresses of devices from which the plurality of requests for content originated.

3. The method as recited in claim 1, wherein the one or more attributes of the plurality of GUI objects further visually depict Internet domain names of devices from which the plurality of requests for content originated.

4. The method as recited in claim 1, wherein the one or the one or more attributes of the plurality of GUI objects further visually depict one or more types of content requested in the plurality of requests for content.

5. The method as recited in claim 1, wherein the one or more attributes of the plurality of GUI objects further visually depict a number of identical requests for content that were received from a particular source from the one or more sources and processed during a specified time.

6. The method as recited in claim 1, wherein the one or more attributes of the plurality of GUI objects further visually depict a total number of requests for content that were received from a particular source from the one or more sources and processed during a specified time.

7. The method as recited in claim 1, wherein the one or more attributes of the plurality of GUI objects further visually depict a total number of requests for content that were received from the one or more sources and processed during a specified time.

8. The method as recited in claim 7, wherein the plurality of GUI objects include a graph that graphically depicts the total number of requests for content that were received from the one or more sources and processed during the specified time.

9. The method as recited in claim 1, wherein the plurality of GUI objects further visually depict one or more times at which the Web server processed the plurality of requests for content.

10. The method as recited in claim 1, wherein the one or more attributes of the plurality of GUI objects include one or more of a number of GUI objects in the plurality of GUI objects, one or more sizes of the plurality of GUI objects, one or more shapes of the plurality of GUI objects, one or more colors of the plurality of GUI objects and one or more locations on the GUI of the plurality of GUI objects.

11. The method as recited in claim 1, further comprising the computer-implemented steps of:
detecting a user selection of a particular GUI object from the plurality of GUI objects, where the particular GUI object visually depicts a source of a particular request for content processed by the Web server; and
in response to detecting the user selection of the particular GUI object from the plurality of GUI objects,
determining a domain name for the source of the particular request, and
generating and displaying on the GUI, a GUI object that specifies the domain name for the source of the particular object.

12. The method as recited in claim 1, further comprising the computer-implemented steps of:
detecting a user selection of a particular GUI object from the plurality of GUI objects, where the particular GUI object visually depicts a status of a particular request for content processed by the Web server; and
in response to detecting the user selection of the particular GUI object from the plurality of GUI objects, generating and displaying on the GUI, a GUI object that specifies contents of the particular request for content processed by the Web server.

13. The method as recited in claim 1, further comprising the computer-implemented steps of:
detecting a user selection of a particular GUI object from the plurality of GUI objects, where the particular GUI object visually depicts a status of a particular request for content processed by the Web server; and
in response to detecting the user selection of the particular GUI object from the plurality of GUI objects, generating and displaying on the GUI, a GUI object that specifies a time at which the particular request for content was processed by the Web server.

14. The method as recited in claim 1, further comprising the computer-implemented step of in response to an error in the processing of a particular request for content from the plurality of requests for content, generating and displaying on the GUI, one or more other GUI objects that visually depict both that the error occurred in the processing of the particular request for content and an approximate time at which a first condition was satisfied that contributed to the error.

15. The method as recited in claim 1, further comprising the computer-implemented step of processing log file data and generating data that specifies requested content by time by Internet Protocol (IP) addresses of devices from which the plurality of requests for content originated.

16. The method as recited in claim 1, further comprising the computer-implemented step of processing log file data and generating data that specifies requested content by URL and HTTP Result Code.

17. The method as recited in claim 16, further comprising the computer-implemented step of processing the data that specifies requested content by URL and HTTP Result Code and for each combination of URL and HTTP Result Code, generating a corresponding GUI object having attributes that are determined at least in part, by the corresponding requested content.

18. A computer-readable medium for visually depicting Web server activity on a Graphical User Interface (GUI), the computer-readable medium carrying one or more sequences of instructions which, when executed by one or more processors, cause the one or more processors to perform the step of:
generating and displaying on the GUI a plurality of GUI objects, wherein one or more attributes of the plurality of GUI objects visually depict, over time, one or more sources and processing status of a plurality of requests for content processed by the Web server.

19. The computer-readable medium as recited in claim 18, wherein the one or more attributes of the plurality of GUI objects further visually depict Internet Protocol (IP) addresses of devices from which the plurality of requests for content originated.

20. The computer-readable medium as recited in claim 18, wherein the one or more attributes of the plurality of GUI objects further visually depict Internet domain names of devices from which the plurality of requests for content originated.

21. The computer-readable medium as recited in claim 18, wherein the one or the one or more attributes of the plurality of GUI objects further visually depict one or more types of content requested in the plurality of requests for content.

22. The computer-readable medium as recited in claim 18, wherein the one or more attributes of the plurality of GUI objects further visually depict a number of identical requests for content that were received from a particular source from the one or more sources and processed during a specified time.

23. The computer-readable medium as recited in claim 18, wherein the one or more attributes of the plurality of GUI objects further visually depict a total number of requests for content that were received from a particular source from the one or more sources and processed during a specified time.

24. The computer-readable medium as recited in claim 18, wherein the one or more attributes of the plurality of GUI objects further visually depict a total number of requests for content that were received from the one or more sources and processed during a specified time.

25. The computer-readable medium as recited in claim 24, wherein the plurality of GUI objects include a graph that graphically depicts the total number of requests for content that were received from the one or more sources and processed during the specified time.

26. The computer-readable medium as recited in claim 18, wherein the plurality of GUI objects further visually depict one or more times at which the Web server processed the plurality of requests for content.

27. The computer-readable medium as recited in claim 18, wherein the one or more attributes of the plurality of GUI objects include one or more of a number of GUI objects in the plurality of GUI objects, one or more sizes of the plurality of GUI objects, one or more shapes of the plurality of GUI objects, one or more colors of the plurality of GUI objects and one or more locations on the GUI of the plurality of GUI objects.

28. The computer-readable medium as recited in claim 18, further comprising one or more additional instructions which, when executed by the one or more processors, cause the one or more processors to perform the steps of:
detecting a user selection of a particular GUI object from the plurality of GUI objects, where the particular GUI object visually depicts a source of a particular request for content processed by the Web server; and
in response to detecting the user selection of the particular GUI object from the plurality of GUI objects,
determining a domain name for the source of the particular request, and
generating and displaying on the GUI, a GUI object that specifies the domain name for the source of the particular object.

29. The computer-readable medium as recited in claim 18, further comprising one or more additional instructions which, when executed by the one or more processors, cause the one or more processors to perform the steps of:
detecting a user selection of a particular GUI object from the plurality of GUI objects, where the particular GUI object visually depicts a status of a particular request for content processed by the Web server; and
in response to detecting the user selection of the particular GUI object from the plurality of GUI objects, generating and displaying on the GUI, a GUI object that specifies contents of the particular request for content processed by the Web server.

30. The computer-readable medium as recited in claim 18, further comprising one or more additional instructions which, when executed by the one or more processors, cause the one or more processors to perform the steps of:
detecting a user selection of a particular GUI object from the plurality of GUI objects, where the particular GUI object visually depicts a status of a particular request for content processed by the Web server; and
in response to detecting the user selection of the particular GUI object from the plurality of GUI objects, generating and displaying on the GUI, a GUI object that specifies a time at which the particular request for content was processed by the Web server.

31. The computer-readable medium as recited in claim 18, further comprising one or more additional instructions which, when executed by the one or more processors, cause the one or more processors to perform the step of in response to an error in the processing of a particular request for content from the plurality of requests for content, generating and displaying on the GUI, one or more other GUI objects that visually depict both that the error occurred in the processing of the particular request for content and an approximate time at which a first condition was satisfied that contributed to the error.

32. The computer-readable medium as recited in claim 18, further comprising one or more additional instructions which, when executed by the one or more processors, cause the one or more processors to perform the step of processing log file data and generating data that specifies requested content by time by Internet Protocol (IP) addresses of devices from which the plurality of requests for content originated.

33. The computer-readable medium as recited in claim 18, further comprising one or more additional instructions which, when executed by the one or more processors, cause the one or more processors to perform the step of processing log file data and generating data that specifies requested content by URL and HTTP Result Code.

34. The computer-readable medium as recited in claim 33, further comprising one or more additional instructions which, when executed by the one or more processors, cause the one or more processors to perform the step of processing the data that specifies requested content by URL and HTTP Result Code and for each combination of URL and HTTP Result Code, generating a corresponding GUI object having attributes that are determined at least in part, by the corresponding requested content.

35. An apparatus for visually depicting Web server activity on a Graphical User Interface (GUI), the apparatus comprising a memory with one or more sequences of instructions which, when executed by one or more processors, cause the one or more processors to perform the step of:
generating and displaying on the GUI a plurality of GUI objects, wherein one or more attributes of the plurality of GUI objects visually depict, over time, one or more sources and processing status of a plurality of requests for content processed by the Web server.

36. The apparatus as recited in claim 35, wherein the one or more attributes of the plurality of GUI objects further visually depict Internet Protocol (IP) addresses of devices from which the plurality of requests for content originated.

37. The apparatus as recited in claim 35, wherein the one or more attributes of the plurality of GUI objects further visually depict Internet domain names of devices from which the plurality of requests for content originated.

38. The apparatus as recited in claim 35, wherein the one or the one or more attributes of the plurality of GUI objects further visually depict one or more types of content requested in the plurality of requests for content.

39. The apparatus as recited in claim 35, wherein the one or more attributes of the plurality of GUI objects further visually depict a number of identical requests for content that were received from a particular source from the one or more sources and processed during a specified time.

40. The apparatus as recited in claim 35, wherein the one or more attributes of the plurality of GUI objects further visually depict a total number of requests for content that were received from a particular source from the one or more sources and processed during a specified time.

41. The apparatus as recited in claim 35, wherein the one or more attributes of the plurality of GUI objects further visually depict a total number of requests for content that were received from the one or more sources and processed during a specified time.

42. The apparatus as recited in claim 41, wherein the plurality of GUI objects include a graph that graphically depicts the total number of requests for content that were received from the one or more sources and processed during the specified time.

43. The apparatus as recited in claim 35, wherein the plurality of GUI objects further visually depict one or more times at which the Web server processed the plurality of requests for content.

44. The apparatus as recited in claim 35, wherein the one or more attributes of the plurality of GUI objects include one or more of a number of GUI objects in the plurality of GUI objects, one or more sizes of the plurality of GUI objects, one or more shapes of the plurality of GUI objects, one or more colors of the plurality of GUI objects and one or more locations on the GUI of the plurality of GUI objects.

45. The apparatus as recited in claim 35, wherein the memory further includes one or more additional instructions which, when executed by the one or more processors, cause the one or more processors to perform the steps of:
detecting a user selection of a particular GUI object from the plurality of GUI objects, where the particular GUI object visually depicts a source of a particular request for content processed by the Web server; and
in response to detecting the user selection of the particular GUI object from the plurality of GUI objects,
determining a domain name for the source of the particular request, and
generating and displaying on the GUI, a GUI object that specifies the domain name for the source of the particular object.

46. The apparatus as recited in claim 35, wherein the memory further includes one or more additional instructions which, when executed by the one or more processors, cause the one or more processors to perform the steps of:
detecting a user selection of a particular GUI object from the plurality of GUI objects, where the particular GUI object visually depicts a status of a particular request for content processed by the Web server; and
in response to detecting the user selection of the particular GUI object from the plurality of GUI objects, generating and displaying on the GUI, a GUI object that specifies contents of the particular request for content processed by the Web server.

47. The apparatus as recited in claim 35, wherein the memory further includes one or more additional instructions which, when executed by the one or more processors, cause the one or more processors to perform the steps of:
detecting a user selection of a particular GUI object from the plurality of GUI objects, where the particular GUI object visually depicts a status of a particular request for content processed by the Web server; and
in response to detecting the user selection of the particular GUI object from the plurality of GUI objects, generating and displaying on the GUI, a GUI object that specifies a time at which the particular request for content was processed by the Web server.

48. The apparatus as recited in claim 35, wherein the memory further includes one or more additional instructions which, when executed by the one or more processors, cause the one or more processors to perform the step of in response to an error in the processing of a particular request for content from the plurality of requests for content, generating and displaying on the GUI, one or more other GUI objects that visually depict both that the error occurred in the processing of the particular request for content and an approximate time at which a first condition was satisfied that contributed to the error.

49. The apparatus as recited in claim 35, wherein the memory further includes one or more additional instructions which, when executed by the one or more processors, cause the one or more processors to perform the step of processing log file data and generating data that specifies requested content by time by Internet Protocol (IP) addresses of devices from which the plurality of requests for content originated.

50. The apparatus as recited in claim 35, wherein the memory further includes one or more additional instructions which, when executed by the one or more processors, cause the one or more processors to perform the step of processing log file data and generating data that specifies requested content by URL and HTTP Result Code.

51. The apparatus as recited in claim 50, wherein the memory further includes one or more additional instructions which, when executed by the one or more processors, cause the one or more processors to perform the step of processing the data that specifies requested content by URL and HTTP Result Code and for each combination of URL and HTTP Result Code, generating a corresponding GUI object having attributes that are determined at least in part, by the corresponding requested content.
